(19) United States
(12) Patent Application Publication
(10) Pub. No.: US 2026/0221074 A1
(43) Pub. Date: Jul. 30, 2026

(54) LAMP PANEL DISPLAY METHOD AND APPARATUS, TERMINAL DEVICE, AND STORAGE MEDIUM

(71) Applicants: ZHEJIANG ZEEKR INTELLIGENT TECHNOLOGY CO., LTD., Ningbo (CN); ZHEJIANG GEELY HOLDING GROUP CO., LTD., Hangzhou (CN)

(72) Inventors: Chen CHEN, Ningbo (CN); Zhibin ZHANG, Ningbo (CN); Xijie ZHANG, Ningbo (CN); Yu QIN, Ningbo (CN)

(73) Assignees: ZHEJIANG ZEEKR INTELLIGENT TECHNOLOGY CO., LTD., Ningbo (CN); ZHEJIANG GEELY HOLDING GROUP CO., LTD., Hangzhou (CN)

(21) Appl. No.: 19/558,007

(22) Filed: Mar. 5, 2026

Related U.S. Application Data
(63) Continuation of application No. PCT/CN2024/140027, filed on Dec. 17, 2024.

(30) Foreign Application Priority Data
Dec. 18, 2023 (CN) 202311746029.X

(51) Int. Cl. G09G 3/20

(52) U.S. Cl. CPC G09G 3/2092; G09G 2320/043; G09G 2330/021; G09G 2330/045; G09G 2360/16

(57) ABSTRACT

A lamp panel display method includes: obtaining an image to be displayed; calculating and obtaining a current parameter corresponding to the image to be displayed; and controlling the lamp panel to display the image to be displayed based on the current parameter. An image display apparatus includes: a data acquisition module configured for obtaining an image to be displayed; a calculation module configured for calculating and obtaining a current parameter corresponding to the image to be displayed; and a display module configured for controlling the lamp panel to display the image to be displayed based on the current parameter.

### CROSS-REFERENCE TO RELATED APPLICATIONS

This application is a continuation application of International Application No. PCT/CN2024/140027, filed on December 17, 2024, which claims priority to Chinese Patent Application No. 202311746029.X, filed on December 18, 2023. The disclosures of the above-mentioned applications are incorporated herein by reference in their entireties.

### TECHNICAL FIELD

The embodiments of the present application relate to, but are not limited to, the technical field of vehicles, and particularly to a lamp panel display method, a lamp panel display apparatus, a terminal device, and a storage medium.

### BACKGROUND

When displaying images by a lamp panel, to avoid excessively rapid aging of the lamp panel components, the heat dissipation structure of the lamp panel is generally optimized and heat dissipation devices (such as radiators, heat sinks, fans, etc.) are added to improve the heat dissipation effect and reduce the operating temperature.

The following is an overview of the subject matter described in detail herein. This overview is not intended to limit the scope of the claims.

Optimizing the heat dissipation structure of the lamp panel and adding heat dissipation devices increases manufacturing costs.

The main purpose of the present application is to provide a lamp panel display method, a lamp panel display apparatus, a terminal device, and a storage medium, aiming to solve the problem that current methods for extending the lifespan of lamp panels increase manufacturing costs.

To achieve the above purpose, the present application provides a lamp panel display method, and the method includes:

obtaining an image to be displayed;

calculating and obtaining a current parameter corresponding to the image to be displayed; and

controlling the lamp panel to display the image to be displayed based on the current parameter.

In some embodiments, the calculating and obtaining a current parameter corresponding to the image to be displayed includes:

calculating pixel data in the image to be displayed, and obtaining a final calculation result, the final calculation result is a pixel value of a brightest region in the image to be displayed; and

querying and obtaining the current parameter based on the final calculation result.

In some embodiments, the calculating pixel data in the image to be displayed, and obtaining the final calculation result includes:

decomposing the image to be displayed, and obtaining at least two images;

dividing the at least two images based on a preset time unit;

performing pixel accumulation on images under at least one time unit, and obtaining at least one calculation result; and

using a maximum value of the at least one calculation result as the final calculation result.

In some embodiments, before the performing pixel accumulation on images under at least one time unit, and obtaining at least one calculation result, the method includes:

filtering the lamp panel based on lamp panel properties, and obtaining a lamp panel to be processed; and

the performing pixel accumulation on images under at least one time unit, and obtaining at least one calculation result includes:

performing pixel accumulation on images displayed by the lamp panel to be processed under at least one time unit, and obtaining at least one calculation result.

In some embodiments, after the performing pixel accumulation on images under at least one time unit, and obtaining at least one calculation result, the method includes:

performing a filtering operation on the at least one calculation result, and obtaining at least one calculation result after the filtering operation; and

the filtering the at least one calculation result, and obtaining a final calculation result includes:

filtering the at least one calculation result after the filtering operation, and obtaining the final calculation result.

In some embodiments, the querying and obtaining the current parameter based on the final calculation result includes:

querying the final calculation result based on a power level conversion table, and obtaining a corresponding power level and current; and

the controlling the lamp panel to display the image to be displayed based on the current parameter includes:

controlling the lamp panel to display the image to be displayed based on the corresponding power level and current.

In some embodiments, the filtering the lamp panel based on lamp panel properties, and obtaining the lamp panel to be processed includes:

filtering the lamp panel based on a lamp panel position and/or a lamp panel category, and obtaining the lamp panel to be processed.

The present application also proposes an image display apparatus, the apparatus includes:

a data acquisition module configured for obtaining an image to be displayed;

a calculation module configured for calculating and obtaining a current parameter corresponding to the image to be displayed; and

a display module configured for controlling the lamp panel to display the image to be displayed based on the current parameter.

The present application also proposes a terminal device, the terminal device includes a memory, a processor, and an image display program stored in the memory and executable on the processor, and the image display program implements the lamp panel display method as described above when executed by the processor.

The present application also proposes a computer-readable storage medium storing the image display program, and the image display program implements the lamp panel display method as described above when executed by a processor.

The lamp panel display method, lamp panel display apparatus, terminal device, and storage medium proposed in the present application embodiment obtain an image to be displayed; calculate and obtain a current parameter corresponding to the image to be displayed; and control the lamp panel to display the image to be displayed based on the current parameter. The embodiment of the present application controls the lamp panel to display the image to be displayed based on the current parameter; by reasonably controlling the current parameter, heat accumulation in the internal components of the lamp panel can be reduced, the aging rate of components can be slowed down, thereby extending the service life of the lamp panel. Furthermore, no additional heat dissipation device is required, thus controlling manufacturing costs.

Other aspects will become clear after reading and understanding the accompanying drawings and detailed description.

### BRIEF DESCRIPTION OF THE DRAWINGS

FIG. 1 is a functional module diagram of a terminal device to which an image display apparatus belongs in the present application.

FIG. 2 is a flowchart illustrating an exemplary embodiment of a lamp panel display method of the present application.

FIG. 3 is a flowchart illustrating another exemplary embodiment of a lamp panel display method of the present application.

FIG. 4 is a flowchart illustrating another exemplary embodiment of a lamp panel display method of the present application.

FIG. 5 is a flowchart illustrating another exemplary embodiment of a lamp panel display method of the present application.

FIG. 6 is a flowchart illustrating another exemplary embodiment of a lamp panel display method of the present application.

FIG. 7 is a flowchart illustrating another exemplary embodiment of a lamp panel display method of the present application.

FIG. 8 is a flowchart illustrating another exemplary embodiment of a lamp panel display method of the present application.

FIG. 9 is a power level conversion table in a lamp panel display method of the present application.

FIG. 10 is a flowchart illustrating another exemplary embodiment of a lamp panel display method of the present application.

The realization of the purpose, functional features and advantages of the present application will be further explained in conjunction with the embodiments and with reference to the accompanying drawings.

### DETAILED DESCRIPTION OF THE EMBODIMENTS

It should be understood that the specific embodiments described herein are merely illustrative of the present application and are not intended to limit the present application.

The main solution of the present application's embodiments is: obtaining an image to be displayed; calculating and obtaining a current parameter corresponding to the image to be displayed; and controlling the lamp panel to display the image to be displayed based on the current parameter. The embodiment of the present application controls the lamp panel to display the image to be displayed based on the current parameter; by reasonably controlling the current parameter, heat accumulation in the internal components of the lamp panel can be reduced, the aging rate of components can be slowed down, thereby extending the service life of the lamp panel. Furthermore, no additional heat dissipation device is required, thus controlling manufacturing costs.

The embodiments of the present application consider that: in related technologies, when displaying images by a lamp panel, to avoid excessively rapid aging of the lamp panel components, the heat dissipation structure of the lamp panel is generally optimized and heat dissipation devices (such as radiators, heat sinks, fans, etc.) are added to improve the heat dissipation effect and reduce the operating temperature. However, optimizing the heat dissipation structure of the lamp panel and adding heat dissipation devices increases manufacturing costs.

Therefore, the present application proposes a solution that controls the lamp panel to display the image to be displayed based on the current parameter; by reasonably controlling the current parameter, heat accumulation in the internal components of the lamp panel can be reduced, the aging rate of components can be slowed down, thereby extending the service life of the lamp panel. Furthermore, no additional heat dissipation device is required, thus controlling manufacturing costs.

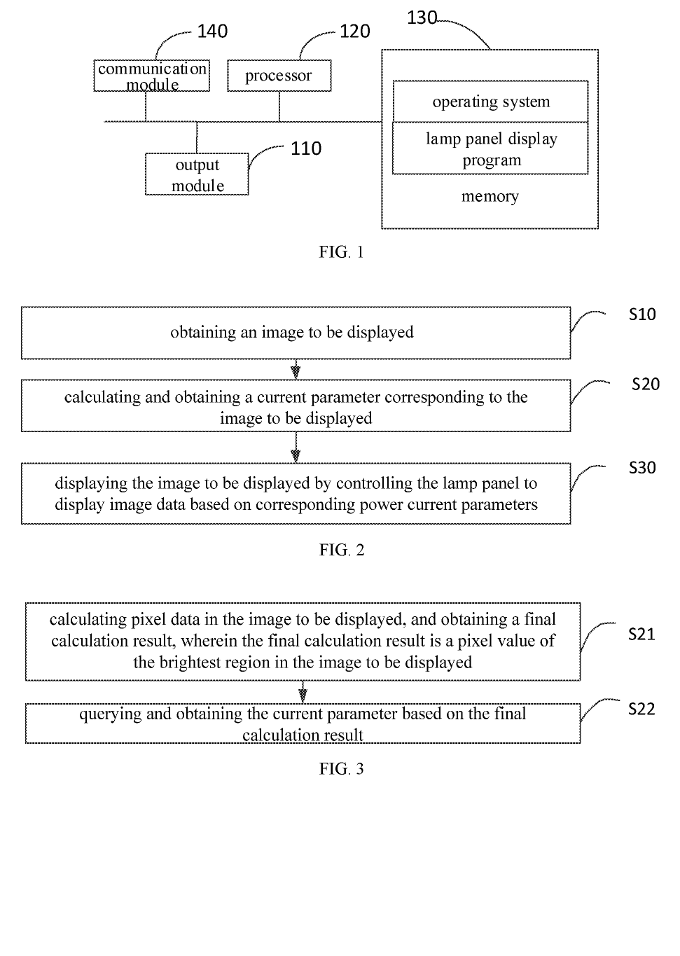

Specifically, referring to FIG. 1, FIG. 1 is a functional module diagram of a terminal device to which an image display apparatus belongs in the present application. This image display apparatus can be apparatus independent of the device and capable of data processing, which can be carried on the device in hardware or software form. This apparatus can be a smart mobile terminal with data processing capabilities, such as a mobile phone or tablet computer, or a fixed device or server with data processing capabilities.

In this embodiment, the device to which the image display apparatus belongs includes at least an output module 110, a processor 120, a memory 130, and a communication module 140.

The memory 130 stores the operating system and the image display program; the output module 110 can be a display screen, etc. The communication module 140 may include a Wi-Fi module and a Bluetooth module, etc., for communication with external devices or servers.

When executed by the processor, the image display program in the memory 130 performs the following steps:

obtaining an image to be displayed;

calculating and obtaining a current parameter corresponding to the image to be displayed; and

controlling the lamp panel to display the image to be displayed based on the current parameter.

Furthermore, when executed by the processor, an image display program in the memory 130 further performs following steps:

calculating pixel data in the image to be displayed, and obtaining a final calculation result, the final calculation result is a pixel value of a brightest region in the image to be displayed; and

querying and obtaining the current parameter based on the final calculation result.

Furthermore, when executed by the processor, the image display program in the memory 130 further performs following steps:

decomposing the image to be displayed, and obtaining at least two images;

dividing the at least two images based on a preset time unit;

performing pixel accumulation on images under at least one time unit, and obtaining at least one calculation result; and

using a maximum value of the at least one calculation result as the final calculation result.

Furthermore, when executed by the processor, the image display program in the memory 130 further performs following steps:

filtering the lamp panel based on lamp panel properties, and obtaining a lamp panel to be processed; and

performing pixel accumulation on images displayed by the lamp panel to be processed under at least one time unit, and obtaining at least one calculation result.

Furthermore, when executed by the processor, the image display program in the memory 130 further performs following steps:

performing a filtering operation on the at least one calculation result, and obtaining at least one calculation result after the filtering operation; and

filtering the at least one calculation result after the filtering operation, and obtaining the final calculation result.

Furthermore, when executed by the processor, the image display program in the memory 130 further performs following steps:

querying the final calculation result based on a power level conversion table, and obtaining a corresponding power level and current; and

controlling the lamp panel to display the image to be displayed based on the corresponding power level and current.

Furthermore, when executed by the processor, the image display program in the memory 130 further performs following steps:

filtering the lamp panel based on a lamp panel position and/or a lamp panel category, and obtaining the lamp panel to be processed.

In this embodiment, by the above scheme, specifically, by obtaining an image to be displayed; calculating and obtaining a current parameter corresponding to the image to be displayed; and controlling the lamp panel to display the image to be displayed based on the current parameter. The embodiment of the present application controls the lamp panel to display the image to be displayed based on the current parameter; by reasonably controlling the current parameter, heat accumulation in the internal components of the lamp panel can be reduced, the aging rate of components can be slowed down, thereby extending the service life of the lamp panel. Furthermore, no additional heat dissipation device is required, thus controlling manufacturing costs.

Based on the above-described device architecture, but not limited to the above-described architecture, the present application proposes a method embodiment.

The executing entity of this embodiment's method can be an image display apparatus, which can be an apparatus independent of the device and capable of data processing, and can be carried on the device in hardware or software form.

Referring to FIG. 2, FIG. 2 is a flowchart illustrating an exemplary embodiment of a lamp panel display method of the present application. The lamp panel display method includes:

Step S10, obtaining an image to be displayed.

The image to be displayed includes pictures, videos, or images generated by drawing.

Step S20, calculating and obtaining a current parameter corresponding to the image to be displayed.

The current parameter corresponding to the image to be displayed includes the power, power level, current, voltage, and inductance of the image to be displayed.

Step S30, controlling the lamp panel to display the image to be displayed based on the current parameter.

The value or state of the current parameter in the lamp panel is adjusted to display the image to be displayed.

In this embodiment, by the above scheme, obtaining an image to be displayed; calculating and obtaining a current parameter corresponding to the image to be displayed; and controlling the lamp panel to display the image to be displayed based on the current parameter. The embodiment of the present application controls the lamp panel to display the image to be displayed based on the current parameter; by reasonably controlling the current parameter, heat accumulation in the internal components of the lamp panel can be reduced, the aging rate of components can be slowed down, thereby extending the service life of the lamp panel. Furthermore, no additional heat dissipation device is required, thus controlling manufacturing costs.

Referring to FIG. 3, FIG. 3 is a flowchart illustrating another exemplary embodiment of a lamp panel display method of the present application.

Based on the embodiment shown in FIG. 2 above, step S20, the calculating and obtaining a current parameter corresponding to the image to be displayed includes:

Step S21, calculating pixel data in the image to be displayed, and obtaining a final calculation result, the final calculation result is a pixel value of the brightest region in the image to be displayed.

If the image to be displayed is a picture, the pixel data of the image to be displayed can be directly calculated to obtain the final calculation result; if the image to be displayed is an animated GIF, video, or drawn image, all or part of the pixel data can be obtained for calculation to obtain the final calculation result.

The calculations performed on the pixel data can include, but are not limited to, the following methods.

(1) Binarization: converting the grayscale image into a binary image.

(2) Filtering: adjusting the pixel values by applying at least one type of filtering, such as smoothing filtering, sharpening filtering, edge detection filtering, etc.

(3) Mathematical operations: performing at least one type of mathematical operation on the pixels in the image, such as addition, subtraction, multiplication, division, etc.

Step S22, querying and obtaining the current parameter based on the final calculation result.

Different calculation results correspond to different current parameters; therefore, the corresponding current parameter can be obtained by querying based on the final calculation result.

The embodiments of the present application adjust the current parameter based on the calculation result of the actual pixel data, which helps to minimize power consumption and thus improve the energy efficiency of the lamp panel.

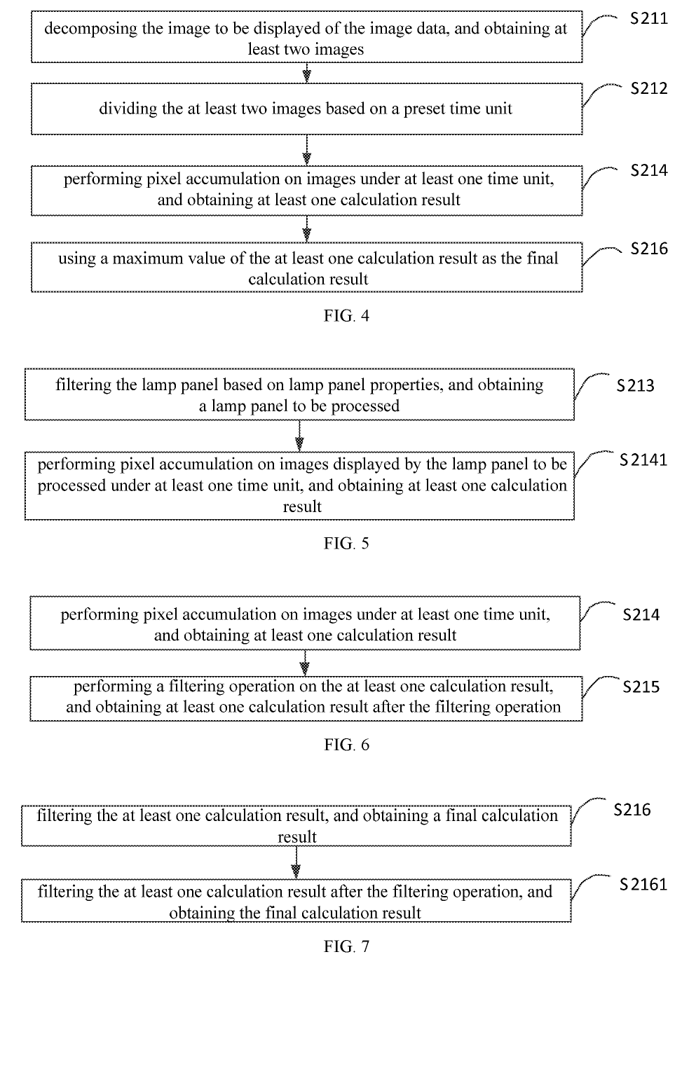

Referring to FIG. 4, FIG. 4 is a flowchart illustrating another exemplary embodiment of a lamp panel display method of the present application.

Based on the embodiment shown in FIG. 3 above, step 21, the calculating pixel data in the image to be displayed, and obtaining a final calculation result includes:

Step S211, decomposing the image to be displayed, and obtaining at least two images.

If the image to be displayed is an animated GIF, video, or drawn image, then the image to be displayed is decomposed into at least two images in frames. For example, a 1-second image to be displayed can be broken down into 30 frames, i.e., 30 images.

Step S212, dividing the at least two images based on a preset time unit.

Assuming the image to be displayed is decomposed into 30 images, and one preset time unit (TimeWindow) corresponds to 10 images, the image to be displayed can be divided into 3 groups sequentially based on this time unit.

Step S214, performing pixel accumulation on images under at least one time unit, and obtaining at least one calculation result.

For example, based on the three groups of images obtained from the above division, pixel accumulation can be performed on the first group of images, the second group of images, and the third group of images respectively to obtain calculation results for at least one group of images.

Each pixel in the image corresponds to a 4-bit grayscale value. Accumulating the values for each pixel in the image yields the calculation result.

Step S216, using a maximum value of the at least one calculation result as the final calculation result.

Obtaining the maximum value in the calculation result corresponding to at least one group of images, and it can be expressed by the following formula: Pixel_max_x = max(at least one group of pixels_x).

Where pixel_x is the calculation result corresponding to at least one group of images.

Where x ∈ [1, n], which represents the group number of the images.

Selecting the maximum value from the calculation results corresponding to at least one group of images as the final calculation result; then, querying and obtaining the current parameter based on this final calculation result, and controlling the lamp panel to display the image to be displayed based on the current parameter. This can obtain the optimal current parameter, ensuring that the brightness of the lamp panel is at its brightest within the range of the current parameter.

As another implementation, at least one calculation result can be filtered based on pre-set filtering rules to obtain the final calculation result.

For example, obtaining the minimum value / median value / value that meets the preset range from the calculation results corresponding to at least one group of images.

The embodiment of the present application divides at least two images based on a preset time unit, then performs pixel accumulation on the images within at least one time unit, this can accurately display the display effect of each time unit; then, filtering the calculation results from at least one time unit to obtain the final calculation result, and this can ensure the accuracy of the final calculation result.

Referring to FIG. 5, FIG. 5 is a flowchart illustrating another exemplary embodiment of a lamp panel display method of the present application.

Based on the embodiment shown in FIG. 4 above, before step S214, the performing pixel accumulation on images under at least one time unit, and obtaining at least one calculation result, it includes:

Step S213, filtering the lamp panel based on lamp panel properties, and obtaining a lamp panel to be processed.

Wherein, lamp panel properties include the size of the lamp panel, the shape of the lamp panel, the material of the lamp panel, the control method of the lamp panel, the position of the lamp panel, the category of the lamp panel, etc.

For example, filtering the lamp panels based on lamp panel properties can be that filtering the lamp panels based on the position of the lamp panel, resulting in that two lamp panels to be processed are a left lamp panel and a right lamp panel.

If a preset time unit (TimeWindow) corresponds to 10 images, then the 10 images within a time unit are further divided based on the left lamp panel and the right lamp panels, and obtaining 20 subarrays.

Step S214, the performing pixel accumulation on images under at least one time unit, and obtaining at least one calculation result includes:

Step S2141, performing pixel accumulation on images displayed by the lamp panel to be processed under at least one time unit, and obtaining at least one calculation result.

In this process, adding up all the 4-bit data extracted from each subarray in each image to obtain the sum of each subarray. There are a total of 20 sets of data. From this, it can get the following equation: SubArray_x = sum of (all of 4 bit data) (x ∈ [0, 19] represents 20 subarrays).

Then, filtering at least one calculation result, and obtaining the final calculation result.

The method for filtering the at least one calculation result can refer to the previous embodiment.

Taking that obtaining the maximum value in the at least one calculation result as an example, the highest pixel value among the 20 data sets can be obtained: Pixel_max_x = max (20 sets of pixel_filter_x).

Where x ∈ [1, n], representing the nth 10th image.

The embodiment of the present application filters the lamp panels based on lamp panel properties, obtains the lamp panels to be processed, thus allowing for a more accurate determination of the lamp panels to be processed.

Referring to FIG. 6, FIG. 6 is a flowchart illustrating another exemplary embodiment of a lamp panel display method of the present application.

Based on the embodiments shown in FIG. 4 and FIG. 5 above, after step S214, the performing pixel accumulation on images under at least one time unit, and obtaining at least one calculation result, it includes:

Step S215, performing a filtering operation on the at least one calculation result, and obtaining at least one calculation result after the filtering operation.

The filtering operation may include high-pass filtering, low-pass filtering, band-pass filtering, etc., thereby performing smoothing or noise reduction, etc. on the numerical values.

For example, performing a filtering operation on the at least one calculation result can be that: dividing the at least one calculation result by the number of images corresponding to at least one time unit, and obtaining the at least one calculation result after the filtering operation. The equation is as follows: pixel_filter_x = sum of (SubArray_x)/TimeWindow.

Where x ∈ [1, n], representing 20 subarrays.

In this case, the number of images in the final extracted time unit may be less than 10. When performing division, the TimeWindow needs to be updated to reflect the number of images.

Referring to FIG. 7, FIG. 7 is a flowchart illustrating another exemplary embodiment of a lamp panel display method of the present application.

Step S216, the filtering the at least one calculation result, and obtaining a final calculation result includes:

Step S2161, filtering the at least one calculation result after the filtering operation, and obtaining the final calculation result.

The method for filtering at least one calculation result after the filtering operation is as described in the previous embodiments.

This embodiment of the present application, by performing a filtering operation on at least one calculation result, makes the calculation result smoother, resulting in a more accurate final calculation result obtained by filtering.

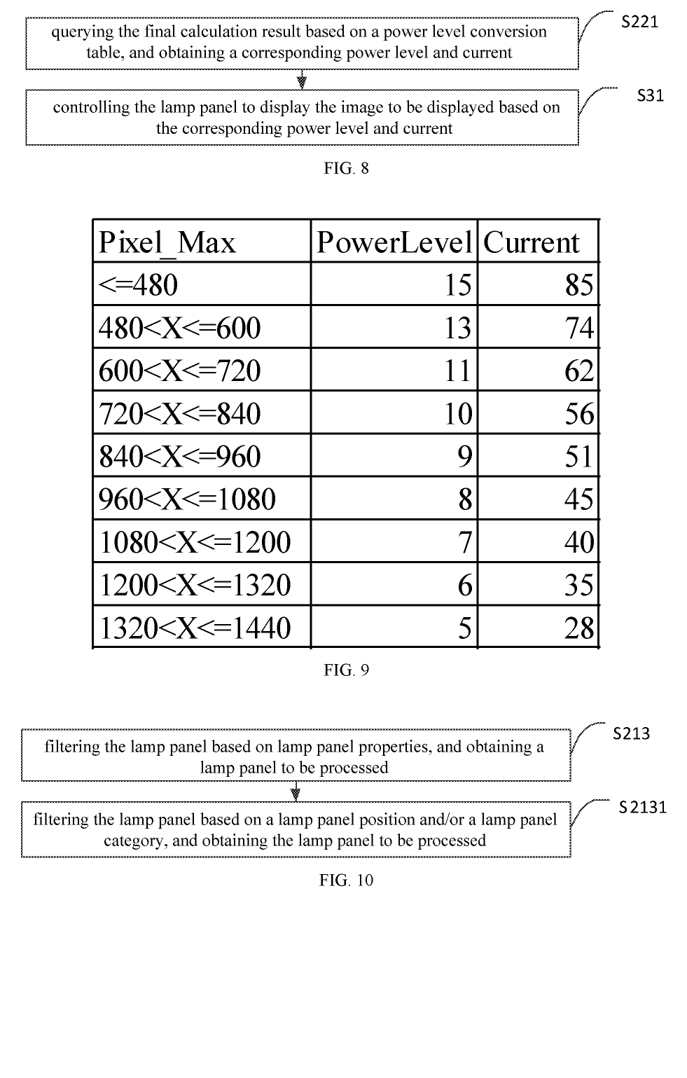

Referring to FIG. 8, FIG. 8 is a flowchart illustrating another exemplary embodiment of a lamp panel display method of the present application.

Based on the embodiment shown in FIG. 3 above, step S22, the querying and obtaining the current parameter based on the final calculation result includes:

Step S221, querying the final calculation result based on a power level conversion table, and obtaining a corresponding power level and current.

Referring to FIG. 9, FIG. 9 is a power level conversion table in a lamp panel display method of the present application.

In the power level conversion table, at least one calculation result corresponds to different power levels and currents.

Step S30, the controlling the lamp panel to display the image to be displayed based on the current parameter includes:

Step S31, controlling the lamp panel to display the image to be displayed based on the corresponding power level and current.

The power level and current values in the lamp panel are adjusted to display the image to be displayed.

Specifically, the obtained power level and current can be transmitted to the lamp panel end via signal values to adjust the power level and current values in the lamp panel.

This embodiment of the present application performs reasonable power allocation based on a power level conversion table, which can balance the usage of the lamp panel, reduce unnecessary wear and aging, and further extend its lifespan.

Referring to FIG. 10, FIG. 10 is a flowchart illustrating another exemplary embodiment of a lamp panel display method of the present application.

Based on the embodiment shown in FIG. 5 above, step S213, the filtering the lamp panel based on lamp panel properties, and obtaining a lamp panel to be processed includes:

Step S2131, filtering the lamp panel based on a lamp panel position and/or a lamp panel category, and obtaining the lamp panel to be processed.

For example, it can filter lamp panels based on lamp panel positions to obtain the lamp panels to be processed as left lamp panel to be processed and right lamp panel to be processed. It can also filter lamp panels based on lamp panel category to obtain lamp panels to be processed as logo lamp panels and non-logo lamp panels; and filter lamp panels based on lamp panel position and lamp panel category to obtain lamp panels to be processed as logo lamp panels, left lamp panels, and right lamp panels.

In an implementation, in the lamp panels to be processed, because the lamp panel position and/or lamp panel category differ, the calculation method for the lamp panel corresponding to different lamp panel positions and/or lamp panel categories also differs.

For example, performing calculation method A on the image displayed by lamp panel to be processed A under at least one time unit, so as to obtain at least one calculation result A; performing calculation method B on the image displayed by lamp panel B under at least one time unit, so as to obtain at least one calculation result B.

The embodiment of the present application performs corresponding processing based on different lamp panels to be processed, which can meet their specific maintenance needs.

Furthermore, the embodiment of the present application also proposes an image display apparatus, the image display apparatus includes:

a data acquisition module configured for obtaining an image to be displayed;

a calculation module configured for calculating and obtaining a current parameter corresponding to the image to be displayed; and

a display module configured for controlling the lamp panel to display the image to be displayed based on the current parameter.

The principle and implementation process of image display in this embodiment are explained in at least one of the above embodiments and will not be repeated here.

Furthermore, the present application also proposes a terminal device, the terminal device includes a memory, a processor, and an image display program stored in the memory and executable on the processor, and the image display program implements the steps of the lamp panel display method as described above when executed by the processor.

Since this image display program employs all the technical solutions of all the aforementioned embodiments when executed by the processor, it possesses at least all the beneficial effects brought about by all the technical solutions of all the aforementioned embodiments, and will not be repeated here.

Furthermore, this application also proposes a computer-readable storage medium storing the image display program, and the image display program implements the steps of the lamp panel display method as described above when executed by a processor.

Since this image display program employs all the technical solutions of all the aforementioned embodiments when executed by the processor, it possesses at least all the beneficial effects brought about by all the technical solutions of all the aforementioned embodiments, which will not be elaborated upon here.

In this embodiment, by the above scheme, specifically, by obtaining an image to be displayed; calculating and obtaining a current parameter corresponding to the image to be displayed; and controlling the lamp panel to display the image to be displayed based on the current parameter. The embodiment of the present application controls the lamp panel to display the image to be displayed based on the current parameter; by reasonably controlling the current parameter, heat accumulation in the internal components of the lamp panel can be reduced, the aging rate of components can be slowed down, thereby extending the service life of the lamp panel. Furthermore, no additional heat dissipation device is required, thus controlling manufacturing costs.

It should be noted that in this article, the terms “comprise”, “include” or any other variation thereof are intended to cover a non-exclusive inclusion, such that a process, method, article or system that includes a list of elements not only includes those elements, but also includes other elements not expressly listed, or also includes elements inherent to the process, method, article or system. In a case of without further restrictions, an element defined by the statement “includes a/an…” does not exclude the existence of other identical elements in a process, method, article or system that includes this element.

It should be noted that the above serial numbers of the embodiments of the present application are only for description and do not represent the advantages and disadvantages of the embodiments.

By the above description of the embodiments, those skilled in the art can clearly understand that the methods of the above embodiments can be implemented by means of software plus the necessary general hardware platform, and they can also be done by hardware certainly, but in many cases the former is the better implementation. Based on this understanding, the technical solution of the present application essentially or the part that contributes to the related art can be embodied in the form of a software product, the computer software product is stored in a storage medium (such as Read Only Memory image (ROM)/Random Access Memory (RAM), diskette, optical disk), which includes several instructions to cause a terminal device (which can be a mobile phone, computer, server, or network device, etc.) to execute the methods described in various embodiments of the present application.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A lamp panel display method, comprising:
obtaining an image to be displayed;
calculating and obtaining a current parameter corresponding to the image to be displayed; and
controlling the lamp panel to display the image to be displayed based on the current parameter.

2. The method according to claim 1, wherein the calculating and obtaining the current parameter corresponding to the image to be displayed comprises:
calculating pixel data in the image to be displayed, and obtaining a final calculation result, wherein the final calculation result is a pixel value of a brightest region in the image to be displayed; and
querying and obtaining the current parameter based on the final calculation result.

3. The method according to claim 2, wherein the calculating pixel data in the image to be displayed, and obtaining the final calculation result comprises:
decomposing the image to be displayed, and obtaining at least two images;
dividing the at least two images based on a preset time unit;
performing pixel accumulation on images under at least one time unit, and obtaining at least one calculation result; and
using a maximum value of the at least one calculation result as the final calculation result.

4. The method according to claim 3, wherein before the performing pixel accumulation on images under at least one time unit, and obtaining at least one calculation result, the method further comprises:
filtering the lamp panel based on lamp panel properties, and obtaining a lamp panel to be processed; and
wherein the performing pixel accumulation on images under at least one time unit, and obtaining at least one calculation result comprises:
performing pixel accumulation on images displayed by the lamp panel to be processed under at least one time unit, and obtaining at least one calculation result.

5. The method according to claim 3, wherein after the performing pixel accumulation on images under at least one time unit, and obtaining at least one calculation result, the method further comprises:
performing a filtering operation on the at least one calculation result, and obtaining at least one calculation result after the filtering operation; and
wherein the filtering the at least one calculation result, and obtaining a final calculation result comprises:
filtering the at least one calculation result after the filtering operation, and obtaining the final calculation result.

6. The method according to claim 2, wherein the querying and obtaining the current parameter based on the final calculation result comprises:
querying the final calculation result based on a power level conversion table, and obtaining a corresponding power level and current; and
wherein the controlling the lamp panel to display the image to be displayed based on the current parameter comprises:
controlling the lamp panel to display the image to be displayed based on the corresponding power level and current.

7. The method according to claim 4, wherein the filtering the lamp panel based on lamp panel properties, and obtaining the lamp panel to be processed comprises:
filtering the lamp panel based on a lamp panel position and/or a lamp panel category, and obtaining the lamp panel to be processed.

8. An image display apparatus, comprising:
a data acquisition module configured for obtaining an image to be displayed;
a calculation module configured for calculating and obtaining a current parameter corresponding to the image to be displayed; and
a display module configured for controlling the lamp panel to display the image to be displayed based on the current parameter.

9. An image display terminal device, comprising a memory, a processor, and a computer program stored in the memory and executable on the processor; wherein when executed by the processor, the computer program performs following steps:
obtaining an image to be displayed;
calculating and obtaining a current parameter corresponding to the image to be displayed; and
controlling the lamp panel to display the image to be displayed based on the current parameter.

10. The image display terminal device according to claim 9, wherein when executed by the processor, an image display program in the memory further performs following steps:
calculating pixel data in the image to be displayed, and obtaining a final calculation result, wherein the final calculation result is a pixel value of a brightest region in the image to be displayed; and
querying and obtaining the current parameter based on the final calculation result.

11. The image display terminal device according to claim 10, wherein when executed by the processor, the image display program in the memory further performs following steps:
decomposing the image to be displayed, and obtaining at least two images;
dividing the at least two images based on a preset time unit;
performing pixel accumulation on images under at least one time unit, and obtaining at least one calculation result; and
using a maximum value of the at least one calculation result as the final calculation result.

12. The image display terminal device according to claim 11, wherein when executed by the processor, the image display program in the memory further performs following steps:
filtering the lamp panel based on lamp panel properties, and obtaining a lamp panel to be processed; and
performing pixel accumulation on images displayed by the lamp panel to be processed under at least one time unit, and obtaining at least one calculation result.

13. The image display terminal device according to claim 11, wherein when executed by the processor, the image display program in the memory further performs following steps:
performing a filtering operation on the at least one calculation result, and obtaining at least one calculation result after the filtering operation; and
filtering the at least one calculation result after the filtering operation, and obtaining the final calculation result.

14. The image display terminal device according to claim 10, wherein when executed by the processor, the image display program in the memory further performs following steps:
querying the final calculation result based on a power level conversion table, and obtaining a corresponding power level and current; and
controlling the lamp panel to display the image to be displayed based on the corresponding power level and current.

15. The image display terminal device according to claim 12, wherein when executed by the processor, the image display program in the memory further performs following steps:
filtering the lamp panel based on a lamp panel position and/or a lamp panel category, and obtaining the lamp panel to be processed.
